(19) United States
(12) Patent Application Publication
(10) Pub. No.: US 2025/0244630 A1
(43) Pub. Date: Jul. 31, 2025

(54) Electrically Conductive Busbar Covers for Electroactive Devices

(71) Applicant: SAGE Electrochromics, Inc., Faribault, MN (US)

(72) Inventors: Frank McGrogan, Faribault, MN (US); Robert J. Anglemier, Waterville, MN (US); Bolei Di, Woodbury, MN (US)

(73) Assignee: SAGE Electrochromics, Inc., Faribault, MN (US)

(21) Appl. No.: 19/019,301

(22) Filed: Jan. 13, 2025

Related U.S. Application Data
(60) Provisional application No. 63/625,675, filed on Jan. 26, 2024.

(51) Int. Cl. G02F 1/155; G02F 1/153; G02F 1/161; G02F 1/163

(52) U.S. Cl. CPC G02F 1/155; G02F 1/1533; G02F 1/161; G02F 2001/1536; G02F 1/163

(57) ABSTRACT

Busbars with electrically conductive covers are implemented for an electroactive device. Different transparent conductive layers may surround an electroactive layer that is between the transparent conductive layers of the electroactive devices. The busbars may include an electrically conductive adhesive tape that includes an adhesion layer, a conductor track, and cover that is electrically conductive toward the conductor track, capable of being soldered or adhered to a conductor, opaque, and satisfy a visibility requirement that obscures the busbar from an environment external to the electroactive device and that is connective using the adhesive layer to one of the transparent conductive layers.

### PRIORITY CLAIM

This application claims benefit of priority to U.S. Provisional Application Ser. No. 63/625,675, entitled “Electrically Conductive Busbar Covers for Electroactive Devices,” filed Jan. 26, 2024, and which is hereby incorporated herein by reference in its entirety.

### FIELD OF THE DISCLOSURE

The present disclosure is directed to busbars with electrically conductive surfaces in electroactive devices, such as an Insulated Glazing Unit (IGU).

### BACKGROUND

Electroactive devices, such as IGUs, offer useful features for a variety of different structures and devices. For example, IGUs may implement “smart” glass, which can be used to decrease heat transfer through a window and/or reduce the transmission of visible light to provide tinting or shading. Smart glass (e.g., an electrochromic device, an electrochromic insulated glass unit (EC-IGU), a device with a glass that changes, for example tint, in response to an input, an electrical charge, and/or the environment) may be used to provide a decrease in solar heat gain through a transparent substrate and a reduction in visible light transmission through a transparent substrate (e.g., a window or glass pane).

An electrochromic device may include electrochromic materials that are known to change their optical properties, such as coloration, in response to the application of an electrical potential, thereby making the transparent substrate more or less transparent or more or less reflective. An electrochromic device can also change its optical properties such as optical transmission, absorption, reflectance and/or emittance in a continual but reversible manner on application of voltage. These properties enable the electrochromic device to be used for applications like smart glasses, electrochromic mirrors, electrochromic display devices, and the like. Electrochromic glass may include a type of glass or glazing for which light transmission properties of the glass or glazing are altered when electrical power (e.g., voltage/current) is applied to the glass. Electrochromic materials may change in opacity (e.g., may changes levels of tinting) when electrical power is applied. A controller may be electrically connected to the electrochromic device using one or more busbars within the IGU in order to provide electrical power. Busbars may be arranged in different ways in order to supply electrical power to different locations of an electrochromic device.

### SUMMARY

In some aspects, an electroactive device is provided. The electroactive device includes a substrate, multiple transparent conductive layers, an electroactive layer between two of the transparent conductive layers and supported by the substrate, and two or more busbars. The busbars may be an electrically conductive adhesive tape, that includes an electrically conductive adhesion layer, a conductor track, and a cover. The cover may be electrically conductive in at least one direction, the one direction being toward the conductor track of the busbar, capable of being soldered or adhered to a conductor, opaque, and satisfying a visibility requirement that obscures the busbar from a view in an environment external to the electroactive device. The busbars may be connected to at least one of the transparent conductive layers.

In some aspects, the two of the busbars of the electroactive device may overlap, where a portion of one busbar adheres to a portion of another busbar. In some aspects, the cover is an applied cover. In some aspects, the cover is a treated surface of the conductor track.

In some aspects, an IGU is provided. The IGU includes two or more panes. The two or more panes may run parallel to one another. The IGU may have one or more seals that form a glazing interior space with the first pane and the second pane. The glazing interior space may include one or more recipient devices and multiple busbars. Each of the busbars may be coupled to at least one of the one or more recipient devices. The busbars may be an electrically conductive adhesive tape, that includes an electrically conductive adhesion layer, a conductor track, and a cover. The cover may be electrically conductive in at least one direction, the one direction being toward the conductor track of the busbar, capable of being soldered or adhered to a conductor, opaque, and satisfying a visibility requirement that obscures the busbar from a view in an environment external to the electroactive device. The busbars may be connected to at least one of the recipient devices.

In some aspects, the two of the busbars of the IGU may overlap, where a portion of one busbar adheres to a portion of another busbar. In some aspects, the cover is an applied cover. In some aspects, the cover is a treated surface of the conductor track.

### BRIEF DESCRIPTION OF THE DRAWINGS

FIG. 1A illustrates an applied, electrically conductive cover of a busbar that satisfies a visibility requirement for an electroactive device, according to some embodiments.

FIG. 1B illustrates a treated surface that provides electrically conductive cover of a busbar and satisfies a visibility requirement for an electroactive device, according to some embodiments.

FIG. 1C illustrates electrical conductivity of a cover toward a conductor track of a busbar, according to some embodiments.

FIGS. 2A through 2C illustrate different angles for connecting busbars with electrically conductive covers, according to some embodiments.

FIG. 3 illustrates an IGU with busbars with electrically conductive covers and different views of a conductor that connects a controller to multiple busbars for one or more recipient devices in the IGU, according to some embodiments.

FIG. 4A illustrates layers in a stack of an electroactive device that include overlapping busbars on top of the stack, according to some embodiments.

FIG. 4B illustrates layers in a stack of an electroactive device that include overlapping busbars within the stack, according to some embodiments.

FIG. 5 illustrates an example obscuration cover that provides a visibility requirement for an IGU that include busbars with an electrically conductive cover that satisfies the visibility requirement, according to some embodiments.

FIG. 6 illustrates an example computer system that may be used in some embodiments.

This specification may include references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units . . . . ” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value. It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the intended scope. The first contact and the second contact are both contacts, but they are not the same contact.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

The terminology used in the description herein is for the purpose of describing particular embodiments only and is not intended to be limiting. As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will further be understood that the term “or” as used herein refers to and encompasses alternative combinations as well as any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. For example, the words “include,” “including,” and “includes” indicate open-ended relationships and therefore mean including, but not limited to. Similarly, the words “have,” “having,” and “has” also indicate open-ended relationships, and thus mean having, but not limited to.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

Whenever a relative term, such as “about”, “substantially” or “approximately”, is used in this specification, such a term should also be construed to also include the exact term. That is, e.g., “substantially straight” should be construed to also include “(exactly) straight”. As used herein, the terms “about”, “substantially”, or “approximately” (and other relative terms) may be interpreted in light of the specification and/or by those having ordinary skill in the art. In some examples, such terms may be as much as 1%, 3%, 5%, 7%, or 10% different from the respective exact term.

While embodiments are described herein by way of example for several embodiments and illustrative drawings, those skilled in the art will recognize that the embodiments are not limited to the embodiments or drawings described. It should be understood that the drawings and detailed description thereto are not intended to limit embodiments to the particular form disclosed, but on the contrary, the intention is to cover all modifications, equivalents and alternatives falling within the spirit and scope as defined by the appended claims. Any headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must).

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

### DETAILED DESCRIPTION

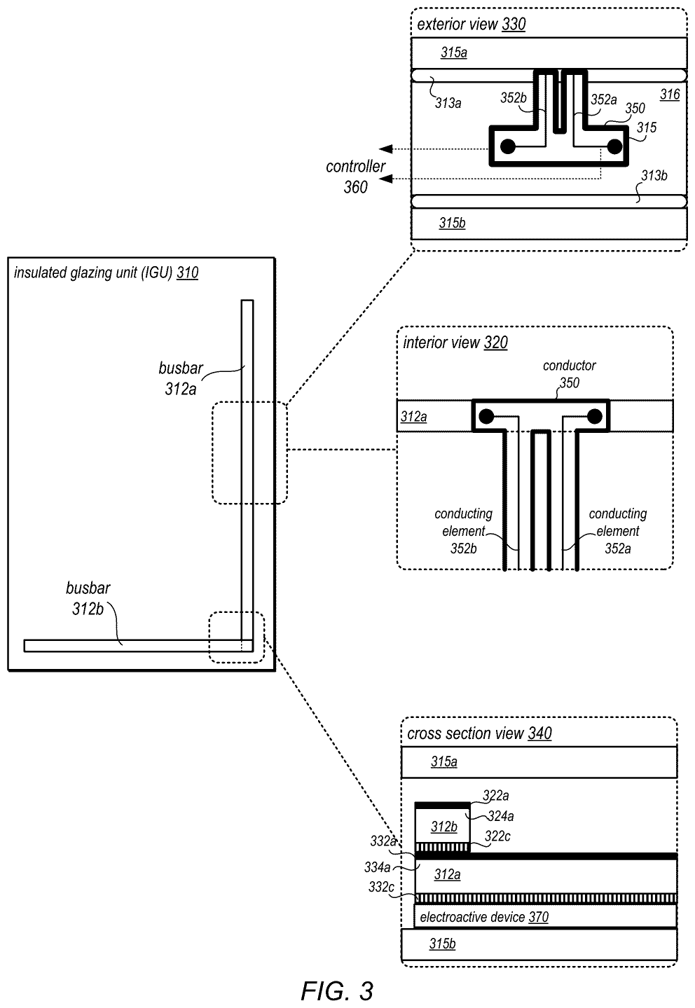

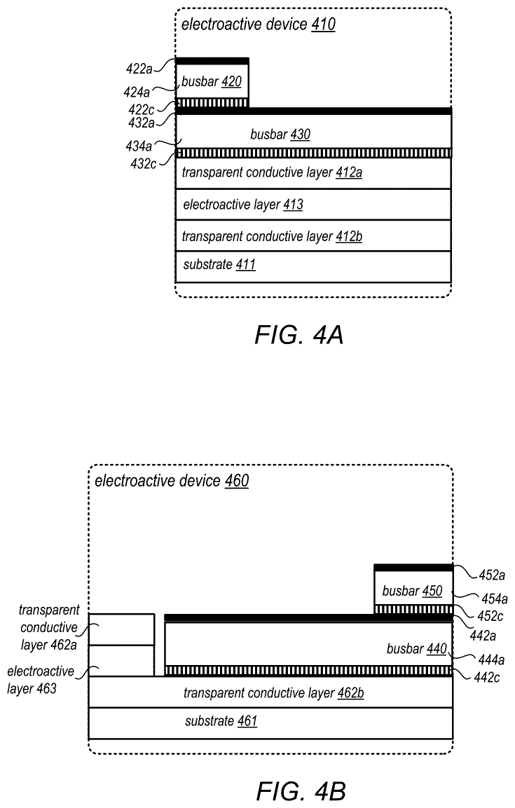

Electroactive devices offer many different capabilities for structures, systems, or other devices that use power and/or control signals to the electroactive device in order to perform different actions. For example, electroactive devices may be integrated with or implemented as electrochromic devices to change various optical properties of the electrochromic devices. These devices can be implemented in various structures, systems, or devices. IGUs offer many different structures or devices, which can include an electrochromic or other electroactive device within an interior space of the glazing, affecting the transparency or other attributes that the IGUs may provide. For example, as discussed in detail below with regard to FIGS. 3-4B, IGUs can be used to implement “smart” glass in order to change window tinting of an IGU, allowing for variations in the amount of light and heat that are passed through an IGU. For buildings and other structures that implement IGUs to act as “smart” windows, other devices too may use an IGU. For example, different appliances, including refrigeration units or other display cabinets may advantageously implement an IGU to introduce transparency for items within the device. Vehicles or other moving structures may also make use of IGUs in order to provide various transparent features.

Given the number of structures and devices which may integrate electroactive devices, such as IGUs, installation challenges can occur. For example, electroactive devices can be installed in different positions, configurations, or other locations that may visibly expose some of the internal components of the electroactive device (e.g., stack layers, controllers, wires, etc.). These components may have varying sensitivity to exposure to light. Additionally, there may be security or aesthetic concerns for allowing certain components to be visible from one or more external views of the electroactive devices. As busbars may be connected to or cover various components of an electroactive device, it may be desirable to use the cover of a busbar to obscure from visibility the busbar itself and/or other components of an electroactive device. However, because busbars provide power and/or control signals to components of an electroactive device, busbar covers that provide both electrical conductivity and satisfy visibility requirements for an electroactive device may be highly desirable in order to overcome various light protection, security, and aesthetic challenges, as noted above.

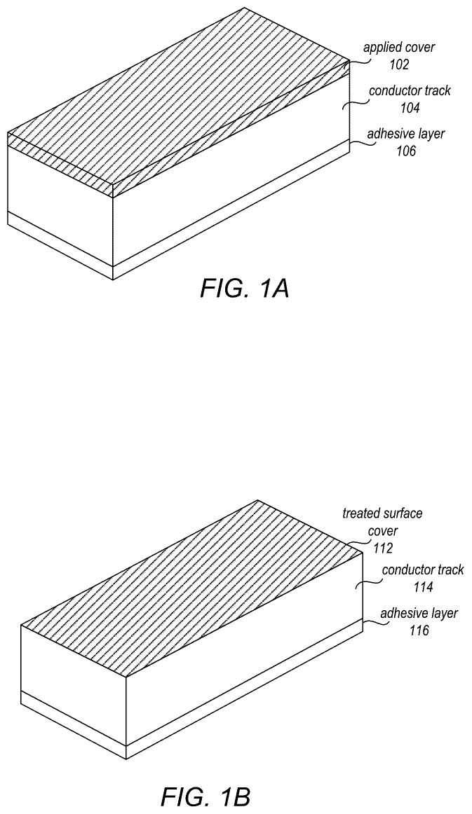

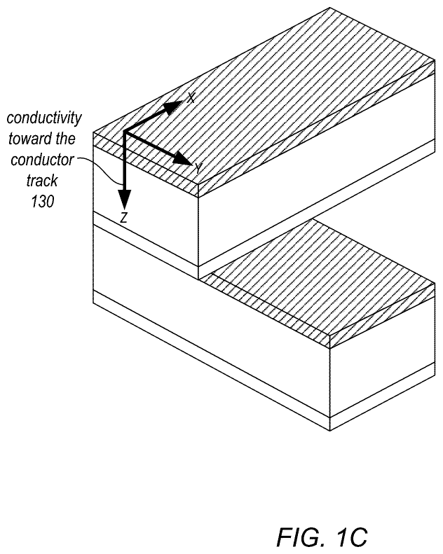

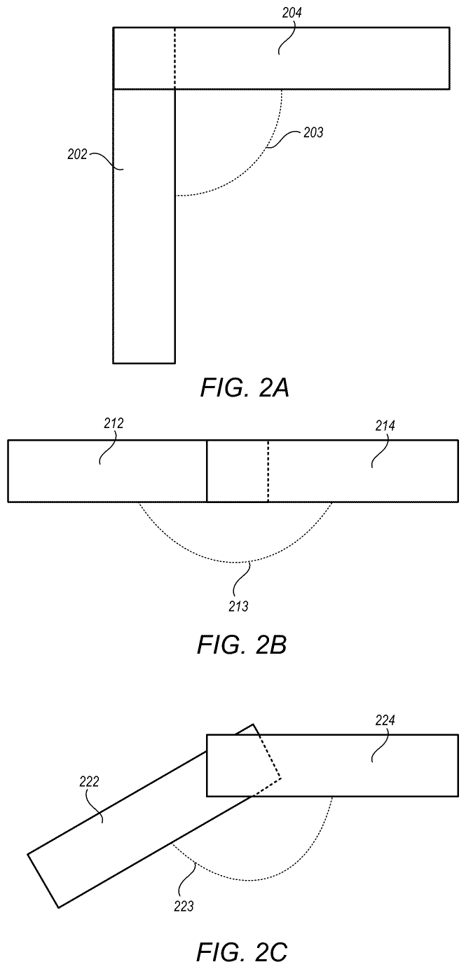

A busbar may be a conductor of power and/or control signals. In various embodiments, a busbar may include a conductor track that is a metal or other sufficiently conductive material to deliver power and/or control signals according to electroactive device design requirements. In at least some embodiments, busbars may be tape busbars that are flexible and can be installed using an adhesive layer that secures the busbar to desired surfaces of an electroactive device while maintaining electrical conductivity. As discussed above, a cover for a busbar may be both electrically conductive and satisfy different visibility requirements. Accordingly, covers for busbars that are both electrically conductive and satisfy different visibility requirements may be implemented in different ways. FIG. 1A illustrates an applied, electrically conductive cover of a busbar that satisfies a visibility requirement for an electroactive device, according to some embodiments. In at least some embodiments, the cover may be opaque and may be capable of being soldered or electrically adhered to a conductor (e.g., a conductor as discussed below with regard to FIG. 3 or another busbar, as discussed below with regard to FIGS. 2A-4B).

The tape-based busbar depicted in FIG. 1A includes adhesive layer 106. Adhesive layer 106 may be electrically conductive so that any surface to which adhesive layer 106 is adhered may receive power and/or control signals from conductor track 104. For example, as depicted in FIGS. 1C-4B, a busbar may at least partially overlap another busbar, adhering to that other busbar in order to continue an electrical connection to provide power and/or control signals along the connected busbar via the electrical connection provided via the adhesive layer 106.

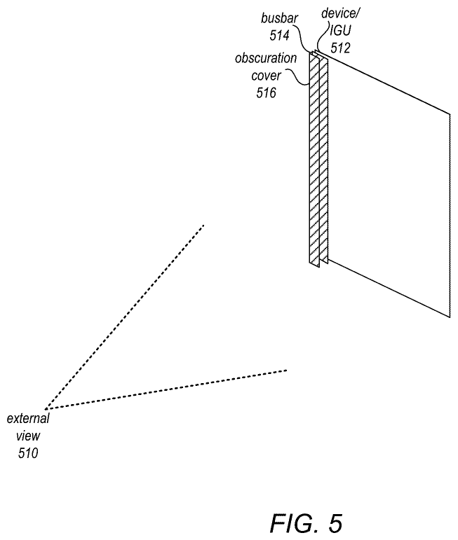

Applied cover 102 may be an electrically conductive material, different from conductor track 104 that is applied (according to respective application processes, methods, or techniques) to conductor track 104 in order to provide a cover to a busbar that is both electrically conductive and satisfying a visibility requirement. A visibility requirement may refer to a color, texture, and/or pattern that obscures or otherwise reduces the visibility of busbar. As discussed below with regard to FIG. 5, this may be provided by an obscuration cover for an electroactive device, or may be provided by the installation location in the device, system, or structure of the electroactive device.

Various applied covers 102 may be used in different embodiments. For example, in one embodiment, a colored conductive epoxy may be applied, which can be used to match a variety of colors of a visibility requirement. Similarly, application of the colored conductive epoxy may be applied to produce a pattern or texture (in addition to a color) according to the visibility requirements color or pattern. Another example embodiment of an applied cover may be carbon black, where carbon black can satisfy the visibility requirement. Carbon black may refer to a material produced by combustion of coal tar, vegetable matter, or petroleum products that gives a dark appearance (e.g., black or dark gray) and is electrically conductive. Other applied covers may include using electroplating of other metals or conductive materials on top of a conductor track that may include, chrome, nickel, molybdenum, or nickel-tin. Another embodiment of an applied cover may be a mixture of various minerals, chemicals, and/or alloying metals that cover another metal (e.g., conductor track 104).

Another type of busbar cover is that of a treated surface of a conductor track of a busbar. FIG. 1B illustrates a treated surface that provides electrically conductive cover of a busbar and satisfies a visibility requirement for an electroactive device, according to some embodiments. In the illustrated example, treated surface cover 112 may be a surface of the conductor track 114 of the busbar (which may also include an adhesive layer 116). Treated surface cover 112 may be produced as a result of various methods, processes, or techniques applied to conductor track 114 that satisfy a visibility requirement for an electroactive device while preserving the electrically conductive properties of conductor track 114. For example, in some embodiments, conductor track 114 may be aluminum and the cover may be anodized to satisfy a visibility requirement. In another example embodiment, the conductor track may be copper, silver, or tin, and the surface may be treated to form a sulfide or selenide that satisfies a visibility requirement. In some embodiments, the conductor track may be copper and the surface oxidized to satisfy a visibility requirement.

As discussed above, a cover of a busbar may be electrically conductive. In order to continue conductivity when overlapped with another busbar (as discussed below with regard to FIGS. 2A-4B, different directions of conductivity should be considered. FIG. 1C illustrates electrical conductivity of a cover toward a conductor track of a busbar, according to some embodiments. Consider two overlapping busbars, as depicted in FIG. 1C, multiple dimensions of conductivity, X, Y, and Z may be envisioned. In the illustrated case, it may be the Z direction that provides conductivity toward the conductor track underneath a cover of the conductor track, as indicated at 130. In this way, power and/or control signal passes from one busbar through the cover of another busbar into its respective conducting track for transmission to a recipient device.

Busbars may be arranged in many different ways in an electroactive device. Because the busbars may be tape-based busbars, in some embodiments, overlapping portions of busbars may also adhered to a common component (e.g., a common surface as depicted in FIG. 4A), in addition to be adhered to one another. FIG. 2A depicts two overlapping busbars, busbar 204 overlapping a portion of busbar 202 (as indicated by the dotted line). This allows for different angles, such as a right angle 203 (or near right angle), which can allow for easy busbar installation in electroactive devices with angles, like IGU 310 discussed below, in order to continue a common power/control signal without the additional components (e.g., bridging components) or processes (e.g., ablating a portion of a component to create an electrical connection or folding components to continue an electrical connection), reducing the number of components in the electroactive device while still satisfying the visibility requirement and delivering power/control signal to desired locations. FIG. 2B illustrates two different busbars, with busbar 214 overlapping a portion of busbar 212 at a different angle 213, providing a straight (or near straight) continuation of a busbar. FIG. 2C illustrates another possible angle 223 (e.g., an obtuse angle) with busbars 222 and 224 overlapping as indicated. Although not depicted various other angles (e.g., an acute angle) could similarly be achieved, and thus the previous examples are not intended to be limiting. In some embodiments, a conductor or other component as discussed below with regard to FIG. 3, that provides power and/or control signals could be included in the overlapping portion to provide an electrical connection without the use of soldering or other additional connective techniques, but instead may rely upon the adhesive layer of busbar 214 to provide electrical connection to busbar 214 and the conductive cover of busbar 212 to provide electrical connection to busbar 212.

As discussed above, electrically conductive busbar covers may be implemented in various electroactive devices including an IGU. FIG. 3 illustrates an IGU with busbars with electrically conductive covers and different views of a conductor that connects a controller to multiple busbars for one or more recipient devices in the IGU, according to some embodiments. Insulated glazing unit 310 may include multiple panes of glass or other transparent material that insulate an interior space between the multiple panes of glass oriented in parallel from an exterior space, outside the IGU 310. IGU 310 may be manufactured for installation into various fittings in structures, such as windows in buildings, or integrated in various devices or other appliances, such as glass doors in refrigeration units.

IGU 310 may offer various features that are implemented by one or more recipient devices located within the interior space of the IGU. For example, an electroactive device (e.g., an electrochromic device), such as electroactive device 370 in cross section view 340, and/or other recipient device (e.g., a sensor, light or other component) may be implemented within the interior space of IGU 310 and may receive power and/or control signals via respective busbars 312a and 312b. Busbars 312a and 312b may be of various types as discussed in detail above with regard to FIGS. 1A-2. The arrangement of busbars 312a and 312b illustrated in FIG. 3 is merely provided as an example. Many arrangements of differing numbers and/or types of busbars may be implemented in other embodiments.

As noted earlier, busbars 312a and 312b may be electrically connected to a controller which may provide the respective power and/or control signals used by the different recipient device(s) in IGU 310 in order to perform respective actions. Accordingly, a conductor may be used, such as conductor 350, to connect the busbars 312a and 312b at a location to the controller 360. Note that in some embodiments, multiple, different connection locations and conductors may be implemented. Accordingly, the below examples are merely examples.

For instance, different views, 320 and 330, may be illustrated for a location indicated on IGU 310. Different locations and different arrangements or embodiments of busbars and conductors may be used in other embodiments. As noted above, the various embodiments of a conductor, such as conductor 350, may allow for many different placement options for connecting busbars. In this way, overlapping or otherwise similarly located busbars within the interior space of IGU 310, such as busbars 312a and 312b, can be connected to a controller at one location, reducing use of materials and creating flexibility in the design of IGUs for installation in different scenarios.

Exterior view 330 illustrates an example embodiment. Conductor 350 may be a flexible conductor, which may be implemented on a substrate, such as a carrier film, which can be shaped (e.g., bent, formed, or otherwise placed) next to an element of an IGU such as spacer 316, to reduce the usage of space by conductor 350 (e.g., to give space to run wires to a controller. In other embodiments, a conductor may be implemented on a substrate that is stiff or otherwise sufficiently rigid so as not to be shaped or placed next to components, such as spacer 316.

Spacer 316 shown in exterior view 330 is just one example of an embodiment that creates or forms an interior space between panes 315a and 315b of IGU 310. In other embodiments, spacers may not be implemented in the vicinity of a stack in an EC device, but other components, such as various seals in and/or around layers of a stack in an EC device, may provide the interior space between panes 315a and 315b.

As shown in exterior view 330, conductor 350 penetrates a seal 313a that is between spacer 316 and pane 315a. Seal 313a and seal 313b may be separately applied, as illustrated in exterior view 330. For example, seal 313a and seal 313b may be butyl in some embodiments. Although not illustrated, in some embodiments, a secondary seal that covers spacer 316 and seals 313a and 313b (which may be considered primary seals) is present. For example, this secondary seal may be silicone.

Conductor 350 penetrates seal 313a and is coupled to one or more busbars, such as busbar 312a. Note that in other embodiments, conductor 350 could penetrate seal 313b, just as busbars 312a could be placed near to pane 315b. Thus, the illustration is merely provided as one example embodiment. Interior view 320 provides one example embodiment of conductor 350. Various other arrangements including multiple “legs” which may be separate parallel extensions joined in an “H”, “T” or other arrangement that join multiple legs into a single conductor. As depicted in interior view 320, busbar 312a is connected to conductor 350.

As shown in cross section view 340 the power and/or control signals may be transmitted to a recipient device (e.g., electroactive device 370) through busbar 312a to busbar 312b as well where they are joined, as discussed below. In the illustrated example, electrical adhesive layer 332c of busbar 312a may be adhered to electroactive device 370 (e.g., as discussed in detail below with regard to FIGS. 4A and 4B). In some embodiments, a portion of busbar 312a could be adhered (at least partially) to other components, such as pane 315b or another component of IGU 310. Note that in other embodiments more than one busbar may be located in a similar location in the interior space of IGU 310. For example, another busbar could run in parallel with busbar 312a in a same plane or another plane, or meet (e.g., in a corner or other location in IGU 310) in a common location at different planes (e.g., vertically in a stack, as depicted in cross section view 340) and be considered to overlap. In interior view 320, conductor 350 includes different respective conducting elements 352a and 352b. Conducting elements 352a and 352b may be coupled to busbar 312a (e.g., via soldering techniques, such as by using soldering pins or pads, or using an electrically conductive adhesive).

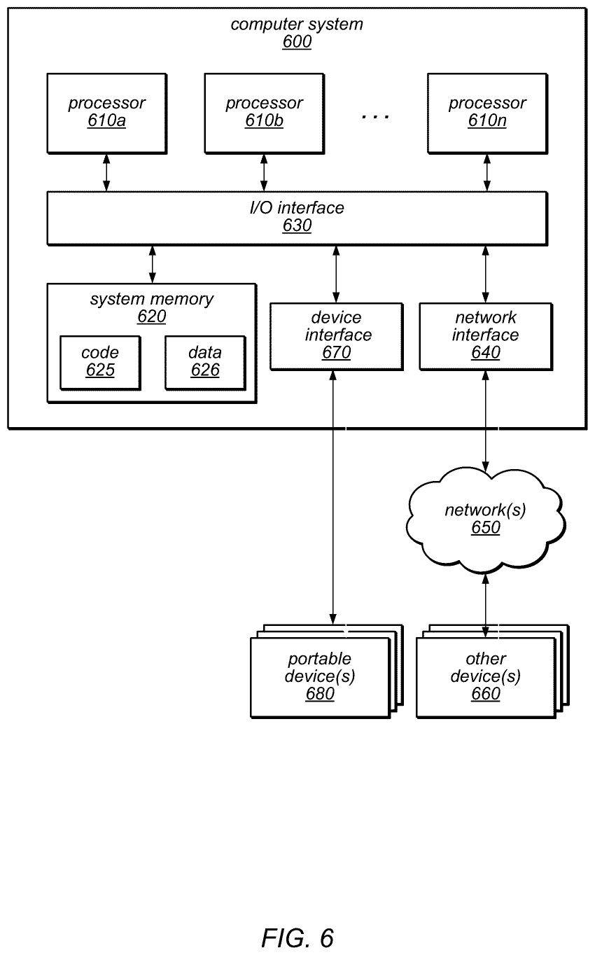

Exterior view 330 illustrates a view of conductor 350 placed next to spacer 316. On the portion of conductor 350 that remains outside of seal 313a, conducting elements 352a and 352b may be electrically coupled with a controller 360. Controller 360 may provide power and/or control signals along conducting elements 352a and 352b via busbar 312a. For example, controller 360 may be implemented using various computer system elements discussed in detail below with regard to system 600 in FIG. 6.

As noted above, a recipient device may be an electroactive device (electroactive device 370 in FIG. 3), such as an electrochromic (EC) device. In at least some embodiments, an EC device may be implemented as “smart” glass. Smart glass may be used to decrease heat transfer through a window and/or reduce the transmission of visible light to provide tinting or shading. A smart glass system including a smart glass (e.g., an EC device, an electrochromic insulated glass unit (EC-IGU), a device with a glass that changes, for example tint, in response to an input, an electrical charge, and/or the environment) may be used to provide a decrease in solar heat gain (e.g., increase in insulation) through a transparent substrate and a reduction in visible light transmission through a transparent substrate (e.g., a window or glass pane). An EC device may include EC materials that are known to change their optical properties, such as coloration, in response to the application of an electrical potential, thereby making the transparent substrate more or less transparent or more or less reflective. An EC device can also change its optical properties such as optical transmission, absorption, reflectance and/or emittance in a continual but reversible manner on application of voltage. These properties enable the EC device to be used for applications like smart glasses, EC mirrors, EC display devices, and the like. EC glass may include a type of glass or glazing for which light transmission properties of the glass or glazing are altered when electrical power (e.g., voltage/current) is applied to the glass. EC materials may change in opacity (e.g., may changes levels of tinting) when electrical power is applied. Many smart glass units and smart glass unit systems rely on complicated and customized tint control schedules and complex three-dimensional models of buildings (e.g., to determine when there is shade and direct sun in specific locations) to control tint levels to meet desired tinting parameters of building occupants.

As discussed above, other devices in addition to or instead of EC devices may be implemented within an IGU 310. These other recipient devices may cover a wide range of sensors, lights, or other components that provide different functions. For example, a recipient device may receive power and/or control signals from a busbar, according to some embodiments. Sensor, light or other recipient devices may implement an electrical connection with a busbar (e.g., busbar 312a or 312b). For example, a direct connection, such as soldering pad or pin may be soldered on a recipient device. In other embodiments, one or more wires may provide the electrical connection with the busbar (which may be soldered or electrically adhered to a busbar).

An electroactive device, whether implemented as part of an IGU like in FIG. 3 above, or in other systems, structures, or devices, may implement busbars with electrically conductive covers. FIG. 4A illustrates layers in a stack of an electroactive device that include overlapping busbars on top of the stack, according to some embodiments. In this example, electroactive device 410 secured to a substrate 411. The electroactive device 410 may, in a non-limiting example, be a smart glass or smart glass unit as provided herein. The electroactive device 410 may include a thin film which may be deposited on to the substrate 411. The electroactive device 410 may include a first transparent conductive (TC) layer 412a and a second TC layer 412b in contact with the substrate 411. In some aspects, the first TC layer 412a and the second TC layer 412b may be, or may include, one or more transparent conductive oxide (TCO) layers. The substrate 411 may include one or more optically transparent materials, e.g., glass, plastic, and the like. The electroactive device 410 may also include one or more active layers. For example, the electroactive device 410 may include an electroactive layer 413, which may be implemented in various ways.

For example, in some embodiments, electroactive layer 413 may include counter electrode (CE) layer in contact with the first TC layer 412a and an electrode (EC) layer in contact with the second TC layer 412b. An ionic conductor (IC) layer may be positioned in-between (e.g., “sandwiched” between) the CE layer and the EC electrode layer. Thus, these three layers CE-IC-EC may together make up the electroactive layer 413.

Electroactive device 410 may include multiple busbars, 420 and 430. These busbars may be arranged so as to overlap, where busbar 420 overlaps with busbar 430. In the depicted embodiment, the overlap may occur at a corner as depicted in FIG. 2A, making a right (or near right) angle. Note that other angles, including that depicted with regard to FIG. 2B, may be implemented in other embodiments. As discussed above with regard to

FIGS. 1A-1B, busbars may be flexible and can be shaped to adhere and make contact with both another busbar (e.g., busbar 420 makes contact with busbar 430) and other components of electroactive device 410 (e.g., transparent conductive layer 412a), such as is depicted in FIG. 2A where busbar 204 may contact the same component as busbar 202 by being bent or shaped to make contact with the component in those areas in which contact is not made with busbar 202 (e.g., the area past the dotted line of busbar 204). In some embodiments, transparent conductive layer 412a may be covered by an additional cover, film or layer (e.g., a silica) that includes various holes, pores, or other openings through which a portion of the conductive adhesive layer 432c may penetrate to make contact with the transparent conductive layer 412a. As discussed in detail above with regard to FIGS. 1A-1C, busbars 420 and 430 may include respective conductive covers 422a and 432a, conductor tracks 424a and 434a, and conductive adhesive layers 422c and 432c. Conductive covers 422a and 432a may satisfy a visibility requirement of electroactive device 410 (or system, structure, or device in which electroactive device 410 is installed).

Busbars 420 and 430 may provide regulated current or voltage to the electroactive device 410. Transparency of the electroactive device 410 may be controlled by regulating density of charges (or lithium ions) in the CE layer and/or the EC electrode layer of the electroactive layer 413. For instance, when a positive voltage from the power supply from busbars 420 and 430 is applied to the first TC layer 412a, lithium ions may be inserted into the EC electrode layer. In some aspects, when a positive voltage from the power supply is applied to the first TC layer 412a, lithium ions may be driven across the IC layer and inserted into the EC electrode layer. Simultaneously, charge-compensating electrons may be extracted from the CE layer, may flow across the external circuit, and may flow into the EC electrode layer. Transfer of lithium ions and associated electrons from the CE layer to the EC electrode layer may cause the electroactive device 410 to become darker—e.g., the visible light transmission of the electroactive device 410 may decrease. Reversing the voltage polarity may cause the lithium ions and associated charges to return to their original layer, the CE layer, and as a result, the electroactive device 410 may return to a clear state—e.g., the visible light transmission of the electroactive device 410 may increase.

As described herein, a smart glass or device such as the electroactive device 410 of FIG. 4A may receive a charge (e.g., a voltage) for controlling a tint of the smart glass. For example, an electrical charge may be provided to a smart glass to increase a level of tint (e.g., darken) of the smart glass. As another example, an electrical charge may be provided to a smart glass to maintain a level of tint of the smart glass. As yet another example, an electrical charge may be provided to a smart glass to decrease a level of tint of the smart glass. As another example, an electrical charge may be provided to a smart glass to clear a tint of the smart glass.

FIG. 4B illustrates layers in a stack of an electroactive device that include overlapping busbars within the stack, according to some embodiments. Similar to FIG. 4A, electroactive device 460 secured to a substrate 461. The electroactive device 460 may, in a non-limiting example, be a smart glass or smart glass unit as provided herein. The electroactive device 460 may include a thin film which may be deposited on to the substrate 461. The electroactive device 460 may include a first transparent conductive (TC) layer 462a and a second TC layer 462b in contact with the substrate 461. In some aspects, the first TC layer 462a and the second TC layer 462b may be, or may include, one or more transparent layers (e.g., one or more conductive oxides or films or layers, such as a fluorinated tin oxide layer or indium tin oxide layer). The substrate 461 may include one or more optically transparent materials, e.g., glass, plastic, and the like. The electroactive device 460 may also include one or more active layers. For example, the electroactive device 460 may include an electroactive layer 463, which may be implemented in various ways.

For example, in some embodiments, electroactive layer 463 may include counter electrode (CE) layer in contact with the first TC layer 462a and an electrode (EC) layer in contact with the second TC layer 462b. An ionic conductor (IC) layer may be positioned in-between (e.g., “sandwiched” between) the CE layer and the EC electrode layer. Thus, these three layers CE-IC-EC may together make up the electroactive layer 463.

Electroactive device 460 may include multiple busbars, 450 and 440. These busbars may be arranged so as to overlap, where busbar 450 overlaps with busbar 440. In the depicted embodiment, the overlap may occur at a corner as depicted in FIG. 2A, making a right (or near right) angle. Note that other angles including that depicted with regard to FIG. 2B, may be implemented in other embodiments. As discussed above with regard to FIGS. 1A-1B, busbars may be flexible and can be shaped to adhere and make contact with both another busbar (e.g., busbar 440 makes contact with busbar 450) and other components of electroactive device 410. For example, busbar 440 may make contact with TC layer 462b. Thus, busbar 440 may be placed in a channel, groove, or other location etched or ablated within the stack of electroactive device 460 to make electrical contact with layers lower in the stack (e.g., TC layer 462b) but not layers 462a and 463. In some embodiments, busbar 440 may be placed in a channel, groove, or other location etched or ablated within the stack of electroactive device 460 to make electrical contact with layers lower in the stack including layers 462a and 463, while not creating an electrical short given a proper electrical isolation of these layers. For example, additional etches or ablations could be made in the upper layers (e.g., transparent conductive layer 462a and electroactive layer 463) to break their respective electrical connectivity with other portions of the same upper layers. In some embodiments, an IGU, as discussed above with regard to FIG. 3 may implement a combination of FIGS. 4A and 4B, where each set of overlapping busbars (420 and 430) and (440 and 450) separately provide power to different transparent conductive layers of a same electroactive device. In some embodiments, busbar 440 may make direct contact with transparent conductive layer 462b. In other embodiments, transparent conductive layer 462b may be covered by an additional cover, film or layer that includes various holes, pores, or other openings through which a portion of the conductive adhesive layer 442c may penetrate to make contact with the transparent conductive layer 462b. As discussed in detail above with regard to FIGS. 1A-1C, busbars 450 and 440 may include respective conductive covers 452a and 442a, conductor tracks 454a and 444a, and conductive adhesive layers 452c and 442c. Conductive covers 452a and 442a may satisfy a visibility requirement of electroactive device 460 (or system, structure, or device in which electroactive device 460 is installed).

Busbars 440 and 450 may provide regulated current or voltage to the electroactive device 460. Similar to the discussion above with regard to FIG. 4A, transparency of the electroactive device 460 may be controlled by regulating density of charges (or lithium ions) in the CE layer and/or the EC electrode layer of the electroactive layer 463. For instance, when a positive voltage from the power supply from busbar 450 is applied to the first TC layer 462a, lithium ions may be inserted into the EC electrode layer. In some aspects, when a positive voltage from the power supply is applied to the first TC layer 462a, lithium ions may be driven across the IC layer and inserted into the EC electrode layer. Simultaneously, charge-compensating electrons may be extracted from the

CE layer, may flow across the external circuit, and may flow into the EC electrode layer. Transfer of lithium ions and associated electrons from the CE layer to the EC electrode layer may cause the electroactive device 460 to become darker—e.g., the visible light transmission of the electroactive device 460 may decrease. Reversing the voltage polarity may cause the lithium ions and associated charges to return to their original layer, the CE layer, and as a result, the electroactive device 460 may return to a clear state—e.g., the visible light transmission of the electroactive device 460 may increase. Similarly, busbar 440 may provide a voltage to TC layer 462 which may cause . . . .

As described herein, a smart glass or device such as the electroactive device 460 of FIG. 4B may receive a charge (e.g., a voltage) for controlling a tint of the smart glass. For example, an electrical charge may be provided to a smart glass to increase a level of tint (e.g., darken) of the smart glass. As another example, an electrical charge may be provided to a smart glass to maintain a level of tint of the smart glass. As yet another example, an electrical charge may be provided to a smart glass to decrease a level of tint of the smart glass. As another example, an electrical charge may be provided to a smart glass to clear a tint of the smart glass.

FIG. 5 illustrates an example obscuration cover that provides a visibility requirement for an IGU that include busbars with an electrically conductive cover that satisfies the visibility requirement, according to some embodiments. Element 512 may be an IGU similar to IGU 310 discussed above with regard to FIG. 3 or other electroactive device, discussed above with regard to FIGS. 1A-2 and 4-5. For the various reasons discussed above, busbar 514 (as well as potentially other busbars not illustrated in FIG. 5), may be implemented as part of device/IGU 512 in order to provide power and/or control signals to various recipient components or devices of device/IGU 512.

In order to prevent busbar 514 from interfering with the aesthetics or other viewing properties of transparent portions of device/IGU 512, obscuration cover 516 may be coupled, connected, or otherwise installed with or adjacent to device/IGU 512 in order to limit or reduce the visibility of busbar 514 (as well as other internal components of device/IGU 512 that may not be transparent, including various wires, spacers, controllers, or other components that may be opaque. Obscuration cover 516 may be implemented using a variety of different materials, including, but not limited to, various types of metal, plastic, or composite material that may be manufactured to block or otherwise obscure from visibility at least a portion of the device/IGU 512 from an external view 510. In some embodiments, obscuration cover 516 may be applied to a pane or other component of an IGU directly (e.g., a printed cover). Note that external view 510 is a view of device/IGU 512 that is external to device/IGU 512. Accordingly, it may be that external view 510 is located in an interior space, exterior space, or other external environment of a structure, device, or other product in which device/IGU is installed 512. Moreover, although only one obscuration cover 516 is depicted, multiple obscuration covers may be implemented in some embodiments (e.g., framing multiple edges of device/IGU 512, such as the top, bottom, left and right sides), as well as implemented on opposite sides of device/IGU 512 (e.g. a second obscuration cover may be implemented on the side of obscuration cover 516).

Obscuration cover 516 may provide a visibility requirement for busbar 514. For example, a visibility requirement may refer to a color, texture, and/or pattern that obscures or otherwise reduces the visibility of busbar 514 (and possibly other components of device/IGU 512) when viewed from external view 510. Note that the visibility may not obscure busbar 514 or other components of device/IGU 512 from all external views, but one external view, in some embodiments. To provide the visibility requirement, obscuration cover 516 may implement a color, texture, and/or pattern which matches or is compatible with the visibility requirement for busbar 514. As discussed in detail above with regard to FIGS. 1A and 1B, the electrically conductive cover of busbars, such as busbar 514, may satisfy the visibility requirement by implementing the corresponding color, texture, and/or pattern that obscures or otherwise reduces the visibility of busbar 514. In some embodiments, a visibility requirement may not be with respect to an obscuration cover, but could correspond to other installation features of the structure, device, or other location in which device/IGU 512 is installed.

FIG. 6 is a block diagram illustrating a computer system 600 according to some aspects, as well as various other systems, components, services, or devices described herein. The computer system 600, for example, may be included in the controller and/or system controllers described herein with respect to FIGS. 1A-5. For example, computer system 600 may implement a controller or other control unit configured to implement and/or utilize the features, methods, mechanisms and/or techniques described herein, in different embodiments. Computer system 600 may be any of various types of devices, including, but not limited to, a personal computer system, desktop computer, laptop or notebook computer, mainframe computer system, handheld computer, workstation, network computer, a consumer device, application server, storage device, telephone, mobile telephone, or in general any type of computing device.

Computer system 600 includes one or more processors 610 (any of which may include multiple cores, which may be single or multi-threaded) coupled to a system memory 620 via an input/output (I/O) interface 630. Computer system 600 further includes a network interface 640 coupled to I/O interface 630. In various embodiments, computer system 600 may be a uniprocessor system including one processor 610, or a multiprocessor system including several processors 610 (e.g., two, four, eight, or another suitable number). Processors 610 may be any suitable processors capable of executing instructions. For example, in various embodiments, processors 610 may be general-purpose or embedded processors implementing any of a variety of instruction set architectures (ISAs), such as the x86, PowerPC, SPARC, or MIPS ISAs, or any other suitable ISA. In multiprocessor systems, each of processors 610 may commonly, but not necessarily, implement the same ISA. The computer system 600 also includes one or more network communication devices (e.g., network interface 640) for communicating with other systems and/or components over a communications network (e.g., Internet, LAN, etc.).

For example, a control unit may receive information and/or commands from one or more other devices requesting that one or more EC devices be changed to a different tint level using the systems, methods and/or techniques described herein. For instance, a user may request a tint change via a portable remote-control device (e.g., a remote control), a wall mounted (e.g., hard wired) device, or an application executing on any of various types of devices (e.g., a portable phone, smart phone, tablet and/or desktop computer are just a few examples). In some embodiments, control unit may monitor sensor signals received measured by and received from a sensor or adjust lighting other recipient device operations in response to user requests.

In the illustrated embodiment, computer system 600 is coupled to one or more portable devices 680 via device interface 670. In various embodiments, portable device(s) 680 may correspond to disk drives, tape drives, solid state memory, other storage devices, or any other persistent storage device. Computer system 600 (or a distributed application or operating system operating thereon) may store instructions and/or data in portable device(s) 680, as desired, and may retrieve the stored instruction and/or data as needed. In some embodiments, portable device(s) 680 may store information regarding one or more EC devices, such as information regarding design parameters, etc. usable by a controller when changing tint levels using the techniques described herein.

Computer system 600 includes one or more system memories 620 that can store instructions 625 and data 626 accessible by processor(s) 610. In various embodiments, system memories 620 may be implemented using any suitable memory technology, (e.g., one or more of cache, static random-access memory (SRAM), DRAM, RDRAM, EDO RAM, DDR 10 RAM, synchronous dynamic RAM (SDRAM), Rambus RAM, EEPROM, non-volatile/Flash-type memory, or any other type of memory). System memory 620 may contain program instructions 625 that are executable by processor(s) 610 to implement the methods and techniques described herein. In various embodiments, program instructions 625 may be encoded in platform native binary, any interpreted language such as Java™ bytecode, or in any other language such as C/C++, Java™, etc., or in any combination thereof. For example, in the illustrated embodiment, program instructions 625 include program instructions executable to implement the functionality of a control unit, a stack voltage measurement module, an electron spin resonance (ESR) module, an open circuit voltage (OCV) module, a supervisory control system, local controller, project database, etc., in different embodiments. In some embodiments, program instructions 625 may implement a control unit configured to implement and/or utilize the features, methods, mechanisms and/or techniques described herein, and/or other components.

In some embodiments, program instructions 625 may include instructions executable to implement an operating system (not shown), which may be any of various operating systems, such as UNIX, LINUX, Solaris™, MacOS™, Windows™, etc. Any or all of program instructions 625 may be provided as a computer program product, or software, that may include a non-transitory computer-readable storage medium having stored thereon instructions, which may be used to program a computer system (or other electronic devices) to perform a process according to various embodiments. A non-transitory computer-readable storage medium may include any mechanism for storing information in a form (e.g., software, processing application) readable by a machine (e.g., a computer). Generally speaking, a non-transitory computer-accessible medium may include computer-readable storage media or memory media such as magnetic or optical media, e.g., disk or DVD/CD-ROM coupled to computer system 600 via I/O interface 630. A non-transitory computer-readable storage medium may also include any volatile or non-volatile media such as RAM (e.g., SDRAM, DDR SDRAM, RDRAM, SRAM, etc.), ROM, etc., that may be included in some embodiments of computer system 600 as system memory 620 or another type of memory. In other embodiments, program instructions may be communicated using optical, acoustical, or other form of propagated signal (e.g., carrier waves, infrared signals, digital signals, etc.) conveyed via a communication medium such as a network and/or a wireless link, such as may be implemented via network interface 640.

In one embodiment, I/O interface 630 may coordinate I/O traffic between processor 610, system memory 620 and any peripheral devices in the system, including through network interface 640 or other peripheral interfaces, such as device interface 670. In some aspects, the network interface 640 and/or the device interface 670 may include a transceiver to wirelessly communicate with the other devices 660 and/or the portable devices 680. In some embodiments, I/O interface 630 may perform any necessary protocol, timing, or other data transformations to convert data signals from one component (e.g., system memory 620) into a format suitable for use by another component (e.g., processor 610). In some embodiments, I/O interface 630 may include support for devices attached through various types of peripheral buses, such as a variant of the Peripheral Component Interconnect (PCI) bus standard or the Universal Serial Bus (USB) standard, for example.

In some embodiments, the function of I/O interface 630 may be split into two or more separate components, such as a north bridge and a south bridge, for example. Also, in some embodiments, some or all of the functionality of I/O interface 630, such as an interface to system memory 620, may be incorporated directly into processor 610.

Network interface 640 may allow data to be exchanged between computer system 600 and other devices attached to a network, such as other computer systems 660. In addition, network interface 640 may allow communication between computer system 600 and various I/O devices and/or remote storage devices. Input/output devices may, in some embodiments, include one or more display terminals, keyboards, keypads, touchpads, scanning devices, voice or optical recognition devices, or any other devices suitable for entering or retrieving data by one or more computer systems 600. Multiple input/output devices may be present in computer system 600 or may be distributed on various nodes of a distributed system that includes computer system 600. In some embodiments, similar input/output devices may be separate from computer system 600 and may interact with one or more nodes of a distributed system that includes computer system 600 through a wired or wireless connection, such as over network interface 640. Network interface 640 may commonly support one or more wireless networking protocols (e.g., Wi-Fi/IEEE 802.11, or another wireless networking standard). However, in various embodiments, network interface 640 may support communication via any suitable wired or wireless general data networks, such as other types of Ethernet networks, for example. Additionally, network interface 640 may support communication via telecommunications/telephony networks such as analog voice networks or digital fiber communications networks, via storage area networks such as Fibre Channel SANs, or via any other suitable type of network and/or protocol. In various embodiments, computer system 600 may include more, fewer, or different components than those illustrated in FIG. 6 (e.g., displays, video cards, audio cards, peripheral devices, other network interfaces such as an ATM interface, an Ethernet interface, a Frame Relay interface, etc.)

The various methods as illustrated in the figures and described herein represent example embodiments of methods. The methods may be implemented manually, in software, in hardware, or in a combination thereof. The order of any method may be changed, and various elements may be added, reordered, combined, omitted, modified, etc.

Although the embodiments above have been described in considerable detail, numerous variations and modifications may be made as would become apparent to those skilled in the art once the above disclosure is fully appreciated. It is intended that the following claims be interpreted to embrace all such modifications and changes and, accordingly, the above description to be regarded in an illustrative rather than a restrictive sense.

What is claimed is:

1. An electroactive device, comprising:
at least one substrate;
a first transparent conductive layer;
a second transparent conductive layer;
an electroactive layer, wherein the electroactive layer is between the two transparent conductive layers and supported by the substrate;
two or more busbars, wherein the two or more busbars respectively comprise:
an electrically conductive adhesive tape, wherein the electrically conductive adhesive tape comprises an electrically conductive adhesion layer, a conductor track, and a cover, wherein the cover is:
electrically conductive in at least one direction, wherein the at least one direction is toward the conductor track;
capable of being soldered or adhered to a conductor;
opaque; and
satisfies a visibility requirement that obscures the busbar from at least one view in an environment external to the electroactive device; and
wherein the electrically conductive adhesive tape is connective via the electrically conductive adhesion layer to at least one of the first or second transparent conductive layers.

2. The electroactive device of claim 1, wherein a portion of the two or more busbars overlap such that a first one of the two or more busbars adheres to a second one of the busbars via a portion of the electrically conductive adhesion layer.

3. The electroactive device of claim 1, wherein the cover is a colored conductive epoxy.

4. The electroactive device of claim 1, wherein the conductor track is copper and the cover is an oxidized surface of the conductor track.

5. The electroactive device of claim 1, wherein the conductor track is copper, silver, or tin, and the cover is a surface of the conductor track formed as a sulfide or selenide.

6. The electroactive device of claim 1, wherein the conductor track is chrome, nickel, molybdenum, or nickel-tin and the cover is electroplated.

7. The electroactive device of claim 1, wherein the conductor track is aluminum and the cover is anodized.

8. The electroactive device of claim 1, wherein the cover is carbon black and wherein the visibility requirement is black.

9. The electroactive device of claim 1, wherein the flexible conductor is coupled to a controller for the electroactive device.

10. An insulated glazing unit (IGU), comprising:
a first pane, a second pane, and one or more seals, wherein the first pane and the second pane run parallel to one another, and wherein the one or more seals form a glazing interior space with the first pane and the second pane;
wherein the glazing interior space comprises one or more recipient devices and two or more busbars, wherein the two or more busbars are coupled to the one or more recipient devices;
wherein the two or more busbars respectively comprise:
an electrically conductive adhesive tape, wherein the electrically conductive adhesive tape comprises an electrically conductive adhesion layer, a conductor track, and a cover, wherein the cover is:
electrically conductive in at least one direction, wherein the at least one direction is toward the conductor track;
capable of being soldered or adhered to a conductor;
opaque; and
satisfies a visibility requirement with respect to an obscuration cover for the IGU; and
wherein the electrically conductive adhesive tape is connective via the electrically conductive adhesion layer to the one or more recipient devices.

11. The IGU of claim 10, wherein a portion of the two or more busbars overlap at a corner of the IGU such that a first one of the two or more busbars adheres to a second one of the busbars via a portion of the electrically conductive adhesion layer.

12. The IGU of claim 10, wherein the cover is a colored conductive epoxy.

13. The IGU of claim 10, wherein the conductor track is copper, and the cover is an oxidized surface of the conductor track.

14. The IGU of claim 10, wherein the conductor track is copper, silver, or tin, and the cover is a surface of the conductor track formed as a sulfide or selenide.

15. The IGU of claim 10, wherein the conductor track is aluminum and the cover is anodized.

16. The IGU of claim 10, wherein the conductor track is chrome, nickel, molybdenum, or nickel-tin and the cover is electroplated.

17. The IGU of claim 10, wherein the cover is carbon black and wherein the visibility requirement is black.

18. The IGU of claim 10, wherein the cover is a colored flux.

19. The IGU of claim 10, wherein the one or more recipient devices is an electrochromic device.

20. The IGU of claim 10, wherein the conductor is coupled to a controller for the one or more recipient devices.
